(19) United States
(12) Patent Application Publication
(10) Pub. No.: US 2026/0320118 A1
(43) Pub. Date: Oct. 15, 2026

(54) IMAGE/AUDIO DISCOVERY USING LOCAL SEARCH CAPABILITIES

(71) Applicant: Oceaneering International, Inc., Houston, TX (US)

(72) Inventors: Carl GILL, Millersville, MD (US); Sudheendra Krishnamurthy, Bengaluru-78 (IN); Christopher Lyon, Bengaluru (IN); Kelly McDowell, Galveston, TX (US)

(73) Assignee: Oceaneering International, Inc., Houston, TX (US)

(21) Appl. No.: 19/648,276

(22) Filed: Apr. 15, 2026

(30) Foreign Application Priority Data
Apr. 15, 2025 (IN) 202511036259

(51) Int. Cl. G06F 16/732; G06V 20/40

(52) U.S. Cl. CPC G06F 16/7335; G06V 20/40

(57) ABSTRACT

An image/audio search processor is used to query a processed a real time streaming protocol (RTSP) stream obtained from a remote source against a database of stock images/audio and the result of query used as input for a Business Unit (BU) Logic Processor for an Onshore Remote Operations Center (OROC Unit) and, optionally, to an OROC Alerts Generator Processor. If an alert is generated, the remote source may be controlled remotely from onshore.

### CROSS-REFERENCE TO RELATED APPLICATIONS

This application claims priority through India Provisional Application 202511036259 filed on Apr. 15, 2025, incorporated herein by reference.

### BACKGROUND OF THE INVENTION

Currently image/audio dimensionality of missions of a remotely operated vehicle (ROV) or an autonomous underwater vehicle (AUV) are not being utilized, even though these data could deepen knowledge of observations and predictions.

### BRIEF DESCRIPTION OF DRAWINGS

Various figures are included herein which illustrate aspects of embodiments of the disclosed inventions.

FIG. 1 is a block diagram of an exemplary system.

### DETAILED DESCRIPTION OF EMBODIMENTS OF THE INVENTION

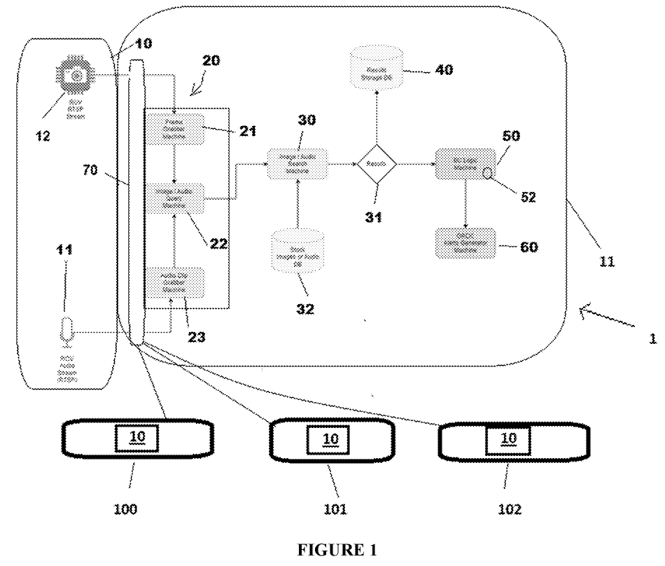

In a first embodiment, referring generally to FIG. 1, system for image/audio discovery using local search capabilities 1 comprises remote source 10 of a real time streaming protocol (RTSP) stream, the RTSP stream comprising video data, audio data, or both video and audio data; transmitter 70 operatively in communication with remote source 10; image/audio data processor 20 operatively in communication with transmitter 70, where image/audio data processor 20 further comprises frame grabber 21 and audio clip grabber 23; database of stock images/audio 32; image/audio query processor 22 operatively in communication with database of stock images/audio 32 and image/audio data processor 20; results storage database 40 operatively in communication with image/audio query processor 22; Business Unit (BU) logic processor 50; and Onshore Remote Operations Center (OROC Unit) 60 operatively in communication with BU logic processor 50.

In embodiments, remote source 10 comprises or is otherwise a part of remotely operated vehicle (ROV) 100, autonomous underwater vehicle (AUV) 101, or aerial drone 102. In these embodiments, the RTSP stream comprises an RTSP stream obtained from ROV 100, AUV 101, or aerial drone 102.

Typically, remote source 10 comprise one or more video stream sources 12 and one or more an audio stream sources 11.

In embodiments, alert generator 52 may be present and operatively in communication with BU logic processor 50.

In embodiments, image/audio search processor 30 may be present and operatively in communication with image/audio query processor 22 and image database 32. In these embodiments, result processor 31 may also be present and disposed intermediate and in communication with image/audio search processor 30 and results storage database 40 and operative to result an output from image/audio search processor 30, provide that output to results storage database 40 such as for storage therein, and able to retrieve a stored output from results storage database 40 and provide it to BU logic processor 50.

In the operation of exemplary methods, referring still to FIG. 1, image/audio discovery using local search capabilities may be accomplished using system for image/audio discovery using local search capabilities 1, which is as described above, by sampling images/audio from the RTSP stream at a predetermined interval to create a set of sampled image/audio data; transmitting the set of sampled image/audio data to OROC Unit 60 such as via transmitter 70; using frame grabber 21 to convert the transmitted set of sampled image/audio data into video frames; using audio clip grabber 23 to convert the transmitted set of sampled image/audio data into audio clips; using image/audio query processor 22 to obtain the video frames and the audio clips, query them against database of stock images/audio 32, and generate a query result; storing the query result in results storage database 40; and providing the query result to BU logic processor 50.

The query result may comprise detection of a stuck valve on a subsea infrastructure, an over torque of a drill bit, an internal leak on a subsea infrastructure, vessel activity, mammal activity, geological activity, a pump failure, a signal lost/not recording status, or an inside cage or ship or sea scenario, or the like, or a combination thereof.

In embodiments, BU logic processor 50 may creating an output which can then be provided to OROC alert generator 52.

In embodiments, a user may be allowed to take control of remote source 10 and complete a desired outcome.

The foregoing disclosure and description of the inventions are illustrative and explanatory. Various changes in the size, shape, and materials, as well as in the details of the illustrative construction and/or an illustrative method may be made without departing from the spirit of the invention.

1. A system for image/audio discovery using local search capabilities, comprising:
a) a remote source of a real time streaming protocol (RTSP) stream, the RTSP stream comprising video data, audio data, or both video and audio data;
b) a transmitter operatively in communication with the remote source;
c) an image/audio data processor operatively in communication with the transmitter, the image/audio data processor further comprising:
i) a frame grabber; and
ii) an audio clip grabber;
d) a database of stock images/audio;
e) an image/audio query processor operatively in communication with the database of stock images/audio and the image/audio data processor;
f) a results storage database operatively in communication with the image/audio query processor;
g) a Business Unit (BU) logic processor; and
h) an Onshore Remote Operations Center (OROC Unit) operatively in communication with the BU logic processor.

2. The system for image/audio discovery using local search capabilities of claim 1, wherein:
a) the remote source comprises a remotely operated vehicle (ROV), an autonomous underwater vehicle (AUV), or an aerial drone; and
b) the RTSP stream comprises an RTSP stream obtained from the ROV, AUV, or aerial drone.

3. The system for image/audio discovery using local search capabilities of claim 1, further comprising an alert generator operatively in communication with the BU logic processor.

4. The system for image/audio discovery using local search capabilities of claim 1, wherein remote source comprises:
a) a video stream source; and
b) an audio stream source.

5. The system for image/audio discovery using local search capabilities of claim 1, further comprising:
a) an image/audio search processor operatively in communication with the image/audio query processor and the image database; and
b) a result processor disposed intermediate and in communication with the image/audio search processor and the results storage database.

6. A method for image/audio discovery using local search capabilities using a system for image/audio discovery using local search capabilities, comprising a remote source of a real time streaming protocol (RTSP) stream which comprises video data, audio data, or both video and audio data; a transmitter operatively in communication with the remote source; an image/audio data processor operatively in communication with the transmitter where the image/audio data processor further comprises a frame grabber and an audio clip grabber; a database of stock images/audio; an image/audio query processor operatively in communication with the database of stock images/audio and the image/audio data processor; a results storage database operatively in communication with the image/audio query processor; a Business Unit (BU) logic processor; and an Onshore Remote Operations Center (OROC Unit) operatively in communication with the BU logic processor; the method comprising:
a) sampling images/audio from the RTSP stream at a predetermined interval to create a set of sampled image/audio data;
b) transmitting the set of sampled image/audio data to the OROC Unit;
c) using the frame grabber to convert the transmitted set of sampled image/audio data into video frames;
d) using the audio clip grabber to convert the transmitted set of sampled image/audio data into audio clips;
e) using the image/audio query processor to query the video frames and the audio clips against the database of stock images/audio and generate a query result;
f) storing the query result in the results storage database; and
g) providing the query result to the BU logic processor.

7. The method for image/audio discovery using local search capabilities of claim 6, further comprising:
a) creating an output from the BU logic processor; and
b) providing the output to an OROC alert generator.

8. The method for image/audio discovery using local search capabilities of claim 7, further comprising allowing a user to take control of the remote source and complete a desired outcome.

9. The method for image/audio discovery using local search capabilities of claim 6, wherein the query result comprises detection of a stuck valve on a subsea infrastructure, an over torque of a drill bit, an internal leak on a subsea infrastructure, vessel activity, mammal activity, geological activity, a pump failure, a signal lost/not recording status, or an inside cage or ship or sea scenario.
